(19) United States
(12) Patent Application Publication
(10) Pub. No.: US 2025/0260091 A1
(43) Pub. Date: Aug. 14, 2025

(54) METHOD FOR PRODUCING AN INTER-CELL COOLING UNIT, INTER-CELL COOLING UNIT AND BATTERY FOR A MOTOR VEHICLE

(71) Applicant: AUDI AG, Ingolstadt (DE)

(72) Inventors: Marc GORMANNS, Erlenbach (DE); Sebastian KUNZE, Dietfurt a.d. Altmühl (DE); Erich LEHNER, Bad Friedrichshall (DE); Daniel SCHMID, Stammham (DE); Michael SCHÜßLER, Neckarsulm (DE); Diana WALENWEIN, lngolstadt (DE)

(73) Assignee: AUDI AG, Ingolstadt (DE)

(21) Appl. No.: 19/040,927

(22) Filed: Jan. 30, 2025

(30) Foreign Application Priority Data
Feb. 12, 2024 (DE) 102024103815.2

(51) Int. Cl. H01M 10/656; B60R 16/033; H01M 10/613; H01M 10/625; H01M 10/647; H01M 10/6554; H01M 50/209

(52) U.S. Cl. CPC H01M 10/656; B60R 16/033; H01M 10/613; H01M 10/625; H01M 10/647; H01M 10/6554; H01M 50/209; H01M 2220/20

(57) ABSTRACT

A method for producing an inter-cell cooling unit. A heat sink extending in a longitudinal extension direction is provided in the form of an extruded profile, which includes an interior with at least one cooling channel through which a coolant can flow, and which is delimited in the longitudinal extension direction by a first end region with a front-side first opening region which opens into the environment. A first connection unit with at least one first connection opening, which is different from the first opening region, is formed from the first end region.

### FIELD

The invention relates to a method for producing an inter-cell cooling unit, wherein a heat sink extending in a longitudinal extension direction is provided in the form of an extruded profile, which comprises an interior with at least one cooling channel through which a coolant can flow, and which is delimited in the longitudinal extension direction by a first end region with a front-side first opening region which opens into the environment. Furthermore, the invention also relates to an inter-cell cooling unit for a battery and a battery for a motor vehicle.

### BACKGROUND

In high-voltage batteries of electric vehicles, for example, heat is generated during rapid charging and when power is requested, which heat should be dissipated as effectively as possible to increase the service life. For this purpose, cooling devices are used in a battery. Often, the heat is dissipated only on one side of a battery cell, namely on the underside of the battery cells through a cooling base on which the battery cells are arranged, for example in the form of cell stacks or battery modules. Prismatic battery cells in particular typically have one side of the cell facing such a cooling base, which side does not represent the largest cell side of such a battery cell in terms of region. By installing a cooling device between the battery cells, however, it would be possible to cool the cells over their largest surfaces and thus particularly efficiently. Due to the large number of battery cells typically installed in a battery, such inter-cell cooling is usually very complex, since a corresponding number of inter-cell cooling units must be provided and these must also be connected to corresponding coolant connections. It would therefore be desirable to be able to design and manufacture such an inter-cell cooling unit as simply and efficiently as possible. Another aspect that makes it difficult to provide such an inter-cell cooling unit efficiently is typically the connection of a connection device to the heat sink comprising the cooling channels. A connecting piece is often provided, which must be attached to such a heat sink in a corresponding manner. Especially in connection with high-voltage batteries or batteries in general, such a connection piece is often sealed multiple times for reasons of technical safety to prevent leaks and, as a result, an accident. However, this is technically very complex and cost-intensive, which means a large overall effort and high costs, especially when there are numerous inter-cell cooling units.

DE 10 2013 209 980 A1 describes a heat exchanger comprising a cooling plate with fluid channels, wherein the cooling plate has openings at opposite ends representing ends of the fluid channels, and wherein a collector is provided at each of the opposite ends of the cooling plate, to which the cooling channels are fluidically connected. The cooling plate can consist of a profile, in particular of metallic material, wherein the collector can be made of a plastic. The collector can comprise multiple nozzles that are inserted into the openings of the fluid channels of the cooling plate.

DE 10 2016 125 859 A1 describes a heat exchanger for an electrical component, wherein the heat exchanger comprises at least one metallic extruded profile as a heat sink for a coolant to flow through, and at least one non-metallic connection body which is hollow on the inside and has a receiving region for the extruded profile. The opening of the receiving region is slightly larger than the cross-section of the extruded profile, wherein a connecting layer is also provided which connects the extruded profile to the connecting body and which provides a mechanically flexible connection between the extruded profile and the connecting body.

### SUMMARY

The object of the present invention is to provide a method, an inter-cell cooling unit and a battery which allow the simplest and most efficient design and manufacture of such an inter-cell cooling unit.

In a method according to the invention for producing an inter-cell cooling unit, a heat sink extending in a longitudinal extension direction is provided in the form of an extruded profile, which comprises an interior with at least one cooling channel through which a coolant can flow, and which is delimited in the longitudinal extension direction by a first end region with a front-side first opening region which opens into the environment. In this case, a first connection unit with at least one first connection opening, which is different from the first opening region, is formed from the first end region.

The first connection unit can thus advantageously be formed integrally with the extruded profile of the heat sink itself. It is therefore not necessary to manufacture and attach a separate component as a connection unit to the heat sink. Thus, the number of components for manufacturing the inter-cell cooling unit can advantageously be reduced, which reduces manufacturing costs and also the complexity of joining. In addition, a double sealing process is no longer necessary, since the integral design of the first connection unit with the heat sink already provides a sealing function and joints are eliminated due to the integral design, which then also no longer need to be sealed. In addition, other joints that may be additionally provided can be designed more simply thanks to the integral construction, for example as welded joints, which are significantly more robust in terms of their tightness than, for example, joints between metallic and non-metallic materials. Overall, an inter-cell cooling unit can thus advantageously be manufactured in a particularly simple and efficient manner and the sealing effort can also be significantly reduced.

The heat sink is designed as an extruded profile. In the unprocessed state, the heat sink correspondingly has a constant cross-section in its longitudinal extension direction perpendicular to its longitudinal extension direction. The heat sink can be delimited on both sides by two open end faces with respect to the longitudinal extension direction. These each comprise an opening region, such as the first opening region in the first end region of the heat sink. This first opening region may comprise one or more openings, for example depending on the number of integrated cooling channels. In principle, the heat sink can be designed in such a way that it only has a continuous interior space which is not divided into individual cooling channels. The interior then represents a cooling channel, in particular the only cooling channel, of the heat sink. However, it is preferred that the interior of the heat sink is divided into multiple cooling channels, for example by means of separating webs running through the interior, as will be explained in more detail later. In this example, each cooling channel can open into the environment in the end region of the heat sink. The first opening region can then have multiple openings, wherein a respective opening can be assigned to a respective cooling channel.

The heat sink is preferably plate-shaped and essentially rectangular in cross-section, i.e. as a whole it is essentially cuboid-shaped. In principle, however, other geometries are also possible. Furthermore, it is preferred that the heat sink is made of a metallic material, for example aluminum or stainless steel. As a result, the heat sink has a particularly high thermal conductivity and is particularly suitable for cooling a component that needs to be cooled, for example battery cells.

To form the at least one first connection opening of the first connection unit, a corresponding opening can be made, for example cut out, in one of the outer sides of the heat sink. It is advantageous that the first connection opening is different from the first opening region. The first connection opening is therefore not provided by the first opening region, but is introduced separately into the heat sink. This allows a more efficient and customized design and arrangement of the coolant supply and discharge connections for the coolant supply and discharge into and out of the inter-cell cooling unit. In this case, the first connection unit in the first end region is designed in particular such that the at least one first connection opening, or also the optionally multiple first connection openings, which are then each different from the first opening region, are the only openings in the first end region that establish a fluidic connection between the interior of the heat sink and the environment. The first opening region of the heat sink itself can be sealed in a fluid-tight manner, for example by welding, as explained in more detail later.

The heat sink can be formed equally in a second end region opposite the first end region with respect to the longitudinal extension direction, i.e. a further second connection unit can also be formed there, analogously to that described for the first connection unit. Therefore, all embodiments of the first connection unit and their construction or manufacture described above and below should also apply analogously to such a second connection unit.

According to a further advantageous embodiment of the invention, the heat sink is provided with at least two cooling channels running in the interior in the longitudinal extension direction, which channels are separated from one another by a separating web running in the interior of the heat sink in the longitudinal extension direction, wherein a portion of the separating web located in at least one first end region and adjacent to the first opening region is removed, in particular milled away. This milling away of the separating webs advantageously makes it possible to fluidically connect to each other the cooling channels in the interior of the heat sink in the first end region. This makes it possible to provide a collection region or distribution region for the first connection unit. For example, coolant can be supplied to the heat sink via the first connection opening and is distributed to the individual cooling channels via this distribution region. Conversely, if the first connection unit is provided for coolant discharge, for example, the coolant from the cooling channels can be collected in this collection region of the first connection unit and discharged via the at least one first connection opening. By milling away the at least one separating web in the first end region, an interior space of the first connection unit is created which is fluidically connected to the respective interior spaces of the respective cooling channels. In the end region, the interior of the heat sink is no longer subdivided or segmented into individual channels by the at least one or more separating webs. This also has the advantage that it facilitates the processing steps explained in more detail below, such as pressing together and/or separating a part of the first end region for the appropriate formation of the first connection unit. If the heat sink in the interior therefore comprises multiple such separating webs running parallel to one another in the longitudinal extension direction, then preferably all of these separating webs in the first end region, i.e. all portions of these separating webs located in the end region, are removed, in particular milled away.

According to a further advantageous embodiment of the invention, the heat sink has a height in a second direction and a width in a third direction which is smaller than the height, wherein the heat sink has two cooling sides which delimit the heat sink on both sides with respect to the third direction, wherein the two cooling sides are pressed against one another in the first end region along a predetermined contour.

The two cooling sides represent the largest outer sides of the heat sink in terms of surface area. A particularly efficient cooling of the adjacent battery cells can thus be provided. The width of the heat sink in the third direction preferably represents its smallest dimension. The width is therefore preferably smaller than the height of the heat sink and also than a length of the heat sink in its longitudinal extension direction.

It is particularly advantageous if the two cooling sides are pressed together in the first end region along a predetermined contour. This predetermined contour can be straight, for example directly adjacent to the first end face of the heat sink in the longitudinal extension direction, or it can be curved. In addition, this contour can have a certain width perpendicular to its extension direction. By pressing the two cooling sides together along this contour, the subsequent step of joining the two cooling sides together along this contour is simplified. In other words, the heat sink can advantageously be sealed fluid-tight along this contour in the first end region, wherein the two cooling sides are initially pressed together in the region of this predetermined contour.

The pressing together along this contour preferably occurs locally. This means that the two cooling sides touch each other in the region of this predetermined contour after pressing together or during pressing together, but do not touch each other in other regions, in particular in a region different from this contour region. By pressing together, in particular the local pressing together of the two cooling sides, the flowability of the heat sink is advantageously not impaired.

The pressing together takes place in particular after the removal of the at least one separating web in the first end region. This makes it easier or even possible for the two cooling sides to be pressed together, in particular for them to be pressed together in a contacting manner, at least if the heat sink comprises multiple cooling channels which are separated from one another by at least one such separating web.

According to a further advantageous embodiment of the invention, after or while the two cooling sides have been or are being pressed together, a part of the first end region is removed, in particular severed, along the predetermined contour. Part of the end region can therefore be cut off. This allows a specific shape to be created for the first connection unit. Regions of the end region that are not functionally important can thus be removed, which in turn saves weight. This part of the first end region to be removed can, for example, be cut off.

According to a further advantageous embodiment of the invention, the two cooling sides are joined together along the predetermined contour, in particular by welding. If a part of the first end region is separated, the two cooling sides are joined along the specified contour after this separation. This means that the two cooling sides can be connected efficiently and particularly in a fluid-tight manner along this predetermined contour. This ultimately seals the original first opening region of the heat sink in a fluid-tight manner.

According to a further advantageous embodiment of the invention, the first connection opening is introduced, in particular cut out, in at least one of the two cooling sides in the first end region, in particular wherein a respective first connection opening is introduced, in particular cut out, in each of the two cooling sides in the first end region, so that the two first connection openings are directly opposite one another in the third direction. Such a first connection opening can be provided, for example, as a hole, in particular a circular hole, into a respective cooling side, e.g. by circularly cutting out a part of such a cooling side. The first connection openings thus produced or the at least one first connection opening can then further be provided with a connection element, e.g. a cooling nipple. This can be provided in the form of a nozzle or similar. Such a connection element can, for example, be welded and/or glued or otherwise fastened or joined to the at least one first connection opening provided.

Such a connection element can, for example, protrude outwards in opposite directions from at least one cooling side or both cooling sides with respect to the third direction. This makes it possible, for example, to arrange multiple inter-cell cooling units provided in this way next to one another in the third direction and to fluidically couple them to one another and/or to connect them to a common coolant supply and/or discharge line.

According to a further advantageous embodiment of the invention, the heat sink is delimited in the second direction by a first delimiting side, wherein the at least one first connection opening in the first end region is provided in the first delimiting side, in particular wherein the predetermined contour, along which the two cooling sides are pressed against one another and joined together, adjoins the end faces delimiting the heat sink in the longitudinal extension direction. In this case, the connection opening can also be arranged on the top or bottom of the heat sink, i.e. on the first delimiting side, which delimits the heat sink with respect to the second direction. When the inter-cell cooling unit is arranged as intended in a motor vehicle, the second direction preferably corresponds to a vertical direction of the vehicle. A battery is preferably provided in such a way that multiple inter-cell cooling units and battery cells, in particular cell bars formed from battery cells, are arranged next to one another or layered in the third direction. The provision of the first connection opening on the first delimiting side thus advantageously makes it possible to supply and/or remove coolant via a cooling system or connection system located, for example, above such a battery arrangement. This saves a lot of installation space, especially in the longitudinal extension direction.

When initially provided, the heat sink can have a length in the longitudinal extension direction that essentially corresponds to the length of such a cell bar. In other words, the heat sink does not have to protrude beyond the gaps between such cell bars in the longitudinal extension direction if such a top-side and/or bottom-side connection option is provided by providing the at least one first connection opening in the first delimiting side. In this case too, the portions of the separating webs in the interior of the heat sink, which are optionally located in the first end region, can first be removed, the heat sink can then be pressed together at the end sides and welded so that its original front opening is closed.

According to a further advantageous embodiment of the invention, a joining region in which the two cooling sides were joined together along the predetermined contour and/or the end region with the formed first connection unit are sealed by means of a sealing substance. Such a sealing substance can also be called a sealant. To make absolutely sure that the seal is secure, the profile, i.e. the heat sink, can be additionally sealed. For this purpose, the heat sink could, for example, be dipped at the front with the first end region into a bath of liquid or viscous sealant, which then hardens. Alternatively or additionally, such a sealant can also be sprayed onto the heat sink using a molding nozzle at the corresponding additionally sealed points, for example at the joint.

According to a further advantageous embodiment of the invention, the heat sink has a second end region opposite the first end region with respect to the longitudinal extension direction and with a front-side second opening region opening into the environment, wherein a second connection unit with at least one second connection opening is formed from the second end region, which second connection opening is different from the second opening region. The second connection unit can be formed in the second end region, as already described in connection with the formation of the first connection unit in the first end region.

This allows coolant supply to be provided through one of the two connection units and coolant discharge through the other.

Furthermore, the invention also relates to an inter-cell cooling unit for a battery which was produced by means of a method according to the invention or one of its embodiments.

The method according to the invention or one of its embodiments can also be part of a method for producing a battery for a motor vehicle, in particular a high-voltage battery.

Furthermore, the invention also relates to a battery for a motor vehicle having an inter-cell cooling unit according to the invention or one of its embodiments.

The battery can be designed for example as a high-voltage battery. In addition, the battery comprises at least one battery cell, preferably multiple battery cells. These battery cells can be formed, for example, as lithium-ion cells. In particular, the battery cells can be designed, for example, as prismatic battery cells. The advantages described in relation to the inter-cell cooling unit according to the invention and its embodiments as well as to the method according to the invention and its embodiments apply in the same way to the battery according to the invention.

According to a further advantageous embodiment of the invention, the battery has a cell bar unit which has an inter-cell cooling unit and a cell bar with a plurality of prismatic battery cells arranged next to one another in a first direction corresponding to the longitudinal extension direction of the inter-cell cooling unit, wherein the cell bar is arranged on the inter-cell cooling unit in such a way that one of the two cell sides with the largest area of a respective battery cell faces the inter-cell cooling unit, in particular wherein the battery comprises a plurality of cell bar units arranged next to one another in the third direction.

This arrangement enables particularly efficient cooling of the battery cells to be provided, since the inter-cell cooling unit can cool the sides of the battery cells with the largest surface area. In addition, the described arrangement can provide a particularly space-saving and efficient structure, because individual battery cells can be arranged next to each other in the form of a cell bar. With an inter-cell cooling unit, not only two adjacent cells in and against the third direction can be cooled, but several adjacent cells in and against the third direction. The number of inter-cell cooling units and their connections can thus be reduced and the effort required for their fluidic interconnection can be reduced enormously. This allows additional installation space, weight, additional connection points and sealing measures to be saved. It is further advantageous if a respective battery cell has two cell poles which are arranged on those cell sides of a respective battery cell which delimit the respective battery cell in and against the first direction. The cell poles can also be referred to as cell terminals. This means that the cell poles of the battery cells of the same cell bar face each other. This allows a particularly simple electrical connection of the battery cells among each other. In addition, it is very advantageous if the battery is constructed from several such cell bar units, for example. Cell bars and inter-cell cooling units can therefore be layered alternately next to each other in the third direction. The inter-cell cooling unit and/or the cell bars can also be inserted or accommodated in a carrier. This is preferably designed in such a way that direct surface contact is still possible between the cell sides of the battery cells with the largest surface area and the inter-cell cooling units adjacent in and/or against the third direction. This makes it possible to provide a particularly space-saving battery with particularly efficient and effective cell cooling.

Furthermore, the invention also relates to a motor vehicle having a battery according to the invention or one of its embodiments.

The motor vehicle according to the invention is preferably designed as an automobile, in particular as a passenger car or truck, or as a passenger bus or motorcycle.

The invention also includes developments of the inter-cell cooling unit and of the battery according to the invention, which have features as already described in the context of the refinements of method according to the invention. For this reason, the corresponding refinements of the inter-cell cooling unit according to the invention and the battery according to the invention are not described again here. Conversely, the features described in connection with the inter-cell cooling unit according to the invention and its embodiments, as well as the features described in connection with the battery according to the invention and its embodiments, enable the further development of the method according to the invention for producing an inter-cell cooling unit and/or a battery by means of further corresponding method steps.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In the figures:

FIG. 1 shows a schematic and perspective exploded representation of a battery having a cell bar unit according to an exemplary embodiment of the invention;

FIG. 2 shows a schematic and perspective illustration of an inter-cell cooling unit according to an exemplary embodiment of the invention;

FIG. 3 shows a schematic representation of an inter-cell cooling unit according to a further exemplary embodiment of the invention.

FIG. 4 shows a schematic representation of an extruded profile for producing an inter-cell cooling unit according to an exemplary embodiment of the invention;

FIG. 5 shows a schematic representation of a part of the heat sink during the production of an inter-cell cooling unit according to an exemplary embodiment of the invention;

FIG. 6 shows a schematic representation of a part of the manufactured heat sink according to an exemplary embodiment of the invention; and

FIG. 7 shows a schematic representation of a connection unit of a heat sink with connection pieces arranged thereon according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

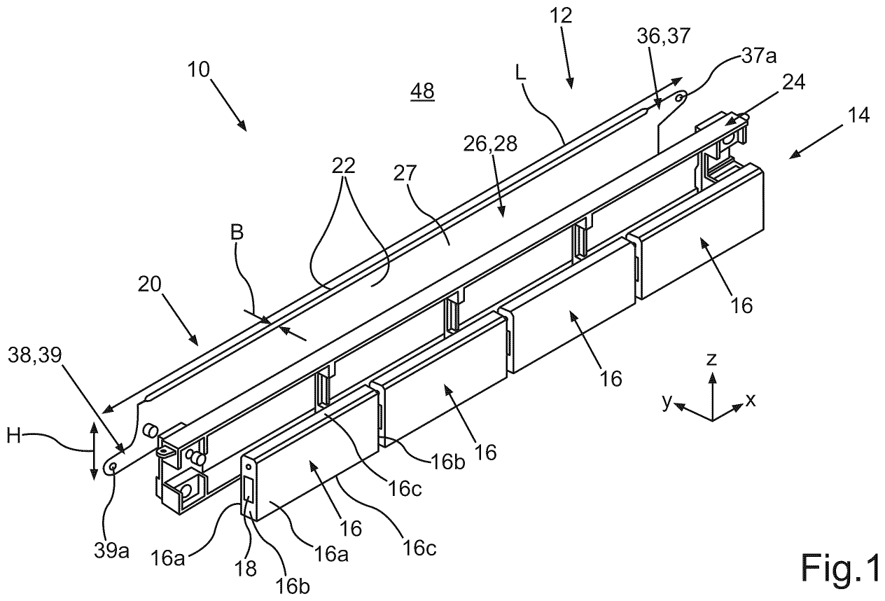

FIG. 1 shows a schematic representation of a battery 10 with a cell bar unit 12 according to an exemplary embodiment of the invention. The cell bar unit 12 is shown in an exploded view. Furthermore, the battery 10 can comprise several such cell bar units 12, which can be arranged next to one another in the illustrated y-direction.

Such a cell bar unit 12 has a cell bar 14 with several prismatic battery cells 16 arranged next to one another in the x-direction. Each of these cells 16 has two sides with the largest area, which are designated 16a here. These sides 16a delimit a respective cell 16 in and against the y-direction. In addition, each cell 16 has two further cell sides 16b opposite each other with respect to the x-direction, on which preferably one of the two cell poles 18 of the cell 16 is arranged for each cell 16. In addition, each cell 16 has a corresponding top and bottom side 16c, which are opposite each other with respect to the z-direction shown. As can be seen in FIG. 1, the cells 16 for forming such a cell bar 14 are not arranged next to one another with their largest area sides 16a facing one another, but with their cell sides 16b, on which the cell poles 18 are also arranged, i.e. with their cell poles 18 facing one another.

Furthermore, the cell bar unit 12 comprises an inter-cell cooling unit 20. This has a length L in the x-direction, which is also referred to as the longitudinal extension direction x, a height H in the z-direction and a width B in the y-direction. The width B is smaller than the height H and this is preferably smaller than the length L of the inter-cell cooling unit 20. The inter-cell cooling unit 20 has two cooling sides 22 or cooling surfaces 22 which are opposite one another with respect to the y-direction. In the assembled state, such a cooling surface 22 lies directly on the cell bar 14, namely on the sides 16a of the battery cells 16 with the largest surface area. A particularly efficient cooling of the cells 16 can thus be provided. In order to hold the cells 16 and the inter-cell cooling unit 20 in position relative to one another and/or to fix them to one another and/or to fix several cell bar units 12 to one another, a carrier 24, which can also be referred to as a holding frame 24, can also be provided. On the one hand, the cells 16 can be inserted and/or clipped into this, and on the other hand, the inter-cell cooling unit 20. In particular, the carrier 24 can serve or be designed, for example, to position the cells 16 relative to one another and to contact their cell poles 18 to one another in the form of a series connection.

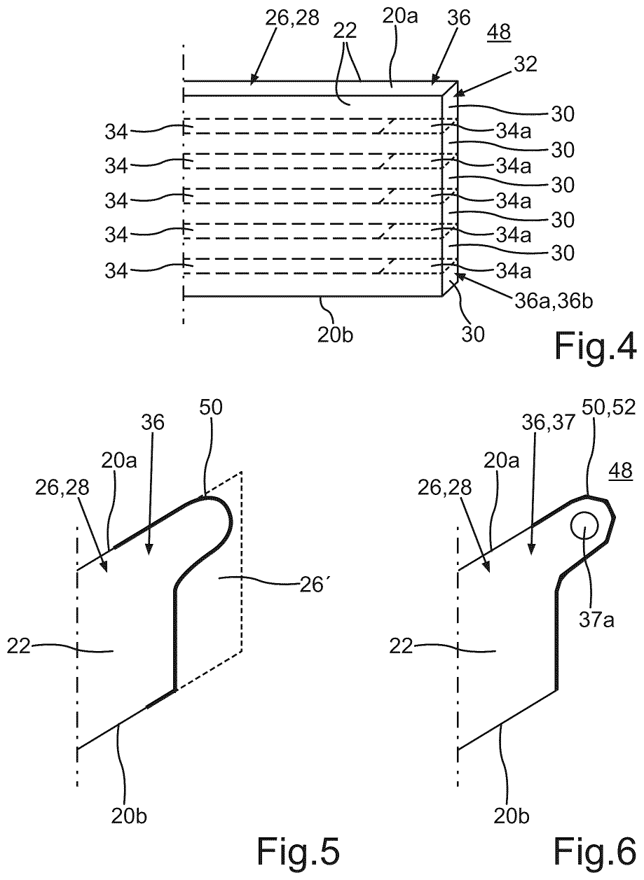

The design of the inter-cell cooling unit 20 is explained in more detail below. This comprises a heat sink 26. This is manufactured as a machined extruded profile 28 and comprises at least one or more integrated cooling channels 30 (see FIG. 4).

The heat sink 26 can be divided in particular into a central region 27 and into at least one end region, for example the first end region 36, and in this example into three regions, namely the central region 27, the first end region 36, and the second end region 38. The first end region 36 is simultaneously designed as a first connection unit 37, which comprises at least one first connection opening 37a. The second end region 38 is analogously designed as a second connection unit 39, which comprises at least one second connection opening 39a. The respective connection units 37, 39 are designed as an integral part of the extruded profile 28 of the heat sink 26, i.e. they are not manufactured as separate components and joined to the heat sink 26, but are formed by a specific processing of the manufactured extruded profile 28. This saves numerous processing steps, as well as material and costs. This also makes sealing the inter-cell cooling unit 20 easier. The manufacturing and design options for these connection units 37, 39 are now explained in more detail below.

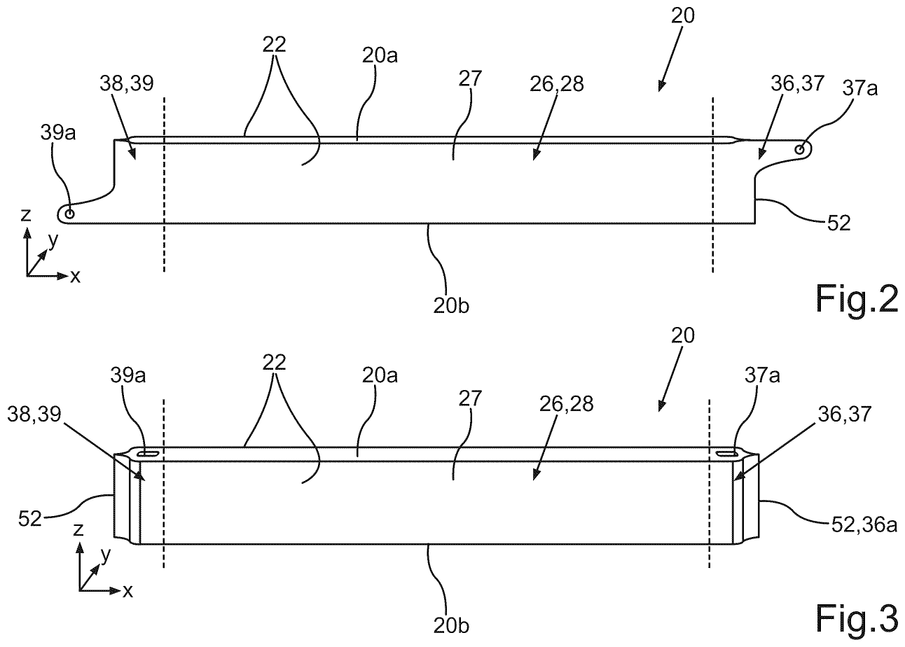

FIG. 2 shows a schematic and perspective representation of an inter-cell cooling unit 20 according to an exemplary embodiment of the invention. The inter-cell cooling unit 20 or the heat sink 26 providing it can again be divided into three regions, namely the central region 27, the first end region 36 and the second end region 38. Since the end regions 36, 38 can be designed identically or similarly or analogously, the design of a connection unit 37 is described in more detail below only with reference to the first end region 36, but can also be implemented in an analogous manner for the second end region 38.

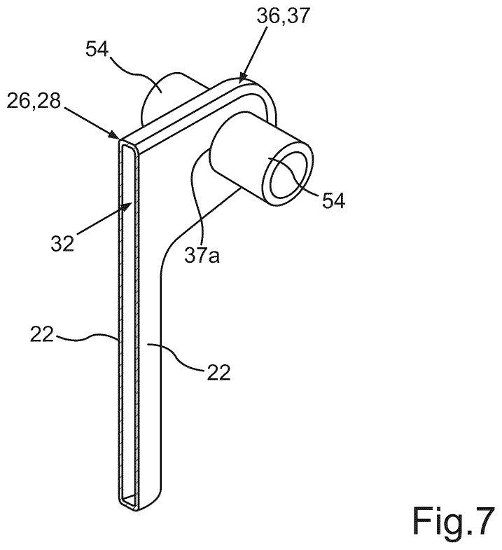

In this example, the first connection unit 37 is designed such that it protrudes from the central region 27 in the longitudinal extension direction x. In this example, the length L of the entire inter-cell cooling unit 20 can be dimensioned such that it is slightly larger than the cell bar 14 (see FIG. 1). This makes it possible to connect the connections 37a laterally, i.e. next to the battery 10 or next to the cell bars 14 in the x-direction. In this example, the connection openings 37a, 39a are also arranged in the cooling sides 22. The connection openings 37a, 39a in the cooling sides 22 can, for example, be round or circular. This allows for easy attachment of nozzle-shaped connection elements 54 (see FIG. 7).

However, it is also conceivable to provide the connections, in particular the connection openings 37a, 39a, not in the cooling sides 22 as in this example, but instead in one of the delimiting sides 20a, 20b, which delimit the heat sink 26 on both sides with respect to the z-direction, as is illustrated by way of example in FIG. 3.

FIG. 3 shows a schematic and perspective representation of a further example of an inter-cell cooling unit 20, in which the connection openings 37a, 39a are arranged exemplarily in the first delimiting side 20a in the respective end regions 36, 38. In this example, the openings 37a, 39a can be elongated in the longitudinal extension direction x.

The production of such an inter-cell cooling unit 20 will now be explained in more detail.

FIG. 4 shows a schematic and perspective representation of a part of the heat sink 26, which is designed as an extruded profile 28, before the formation of the first connection unit 37. The heat sink 26 in turn has the described cooling sides 22, which delimit the heat sink 26 on both sides with respect to the y-direction, as well as the two delimiting sides 20a, 20b, which delimit the heat sink 26 on both sides with respect to the z-direction. The extruded profile 28 is open at the front in and against the x-direction. The heat sink 26 has an interior 32. There is at least one cooling channel 30. In the present example, the interior 32 is subdivided into several cooling channels 30 by respective separating webs 34 located between the cooling channels 30 or separating them from one another. These separating webs 34 can extend from one cooling side 22 to the opposite cooling side 22. In addition, they run parallel to each other in the longitudinal extension direction x. For the first end region 36, a first end face 36a with a first opening region 36b can be defined. The opening region 36b is subdivided by the individual openings of the respective channels 30 or comprises them.

To form the first connection unit 37, the portions 34a of the respective separating webs 34, which are located in the first end region 36, are now removed, for example milled away. The first end region 36 of the extruded profile 28 before machining can be defined, for example, such that, starting from the first end face 36a in the x-direction, it has a length of, for example, between 2 centimeters and 10 centimeters, for example between 3 centimeters and 8 centimeters, for example approximately 5 centimeters. Thus, for example, starting from the front side 36a, the separating web portions 34a can be removed over a length of, for example, 5 centimeters.

In the next manufacturing step, which is illustrated in FIG. 5, the two cooling sides 22 are pressed together along a predetermined contour 50, in particular such that these cooling sides 22 touch each other in the region of this contour 50 or lie in contact with each other. In addition, a part of the heat sink 26′ can be removed or separated along this contour 50. The separated part is presently designated 26′. In a further step, which is schematically illustrated in FIG. 6, the two cooling sides 22 can be joined together by means of a joining connection 52 along the contour 50, for example by being welded together. In addition, during or before or after this, the at least one connection opening 37a can be provided by cutting it out of at least one of the cooling sides 22, in the present example, cutting it out of both cooling sides 22, so that the two openings 37a are directly opposite each other with respect to the y-direction.

When producing such an individual part, namely the inter-cell cooling unit 20, from the extruded profile 28, the connection option, namely the first connection unit 37 and/or the second connection unit 39, to the central cooling can be integrated immediately.

This can be done, for example, by making the extruded profile 28 approximately 10 cm longer than later required, i.e., for example, 10 cm longer than the length of a cell bar 14 in the longitudinal extension direction x.

The inner webs 34, which were previously also referred to as separating webs 34, which run in the longitudinal extension direction x, can be removed from the front side with a milling cutter over a length of, for example, 5 cm from the end or from the front side 36a of the profile 28. This results in a square open cross-section without such central webs 34 or separating webs 34 on the last 5 cm at the beginning and end of the profile 28, i.e. in both end regions 36, 38. The two large side surfaces 22 of the extruded profile 28, i.e. the cooling sides 22, can then be pressed together in a press so that the gap inside the extruded profile 28 is locally compressed to a height of 0 cm. At the same time, the press also preferentially punches away excess material 26′. The result is a profile 28, as shown, for example, in FIG. 5. In particular, the press also punches out a hole 37a, which later serves for the connection to the central cooling system. This hole 37a was also called connection opening 37a. A cooling nipple 54 or, in general, a connection element 54 can then be introduced into the hole 37a, as described in more detail in FIG. 7. This can be joined to the extruded profile 28, for example by welding. The side surfaces of the extruded profile 28, which are still open but compressed to a gap of 0 cm, can then be joined together at the end face, namely along the contour 50, for example by means of sealing welding. The result is the component as shown, for example, partially in FIG. 6 and in FIG. 7.

FIG. 7 shows in particular a schematic and perspective representation of at least a part of the connection unit 37 thus formed, in which additional connection pieces 54 were attached to these openings 37a on both sides and protruding from the openings 37a with respect to the y-direction, for example by being welded and/or glued or similar. The nozzles 54 can also be made of a metallic material or of a plastic.

The joining connection 52 described in FIG. 6, which can be designed as a weld seam, for example, closes the original opening region 36b of the extruded profile 28. This joining contour 52 is also shown as an example in FIG. 2. In the embodiment variant in which the connection openings 37a, 39a are arranged on one of the two delimiting sides 20a, 20b, the predetermined contour 50, along which the two cooling sides 22 are pressed together and which are also joined together via the joining connection 52, can run adjacent to the end face 36a of the extruded profile 28, in particular in a straight line along the z-direction, as shown by way of example in FIG. 3.

Optionally, an additional sealing step can be added. For example, the profile 28 can be dipped on its corresponding end faces 36a after the formation of the respective connection units 37, 39 into a bath of liquid sealant, which then hardens, or the corresponding regions to be sealed can be sprayed with a sealant by means of a molding nozzle.

Overall, the examples show how the invention can provide a new battery concept with integral cell-near cooling and optimized cooling connection. In this case, an extruded profile can already be equipped with a connection option, namely at least one first connection unit, for central cooling during the production of the individual part. This has the advantage that the number of components is reduced, which reduces manufacturing costs and also the complexity of joining. In addition, the double sealing process is no longer necessary to be doubled, since the individual part is already provided with a first sealing function. This reduces the risk of leakage.

1. A method for producing an inter-cell cooling unit, comprising: providing a heat sink extending in a longitudinal extension direction in the form of an extruded profile, which comprises an interior with at least one cooling channel through which a coolant can flow, and which is delimited in the longitudinal extension direction by a first end region with a front-side first opening region which opens into the environment,
wherein a first connection unit with at least one first connection opening, which is different from the first opening region, is formed from the first end region.

2. The method according to claim 1, wherein the heat sink is provided with at least two cooling channels running in the interior in the longitudinal extension direction, which are separated from one another by a separating web running in the interior of the heat sink in the longitudinal extension direction, wherein at least one portion of the separating web located in the first end region and adjacent to the first opening region is removed, in particular milled away.

3. The method according to claim 1, wherein the heat sink has a height in a second direction, and a width in a third direction which is smaller than the height, wherein the heat sink has two cooling sides which delimit the heat sink on both sides with respect to the third direction, wherein the two cooling sides are pressed against one another in the first end region along a predetermined contour.

4. The method according to claim 1, wherein after or while the two cooling sides have been or are being pressed together, a part of the first end region is removed along the predetermined contour, in particular is severed.

5. The method according to claim 1, wherein the two cooling sides are joined together along the predetermined contour, in particular by welding.

6. The method according to claim 1, wherein in the first end region, the first connection opening is introduced, in particular cut out, into at least one of the two cooling sides, in particular wherein a respective first connection opening is introduced, in particular cut out, into each of the two cooling sides in the first end region, so that the two first connection openings are directly opposite one another in the third direction.

7. The method according to claim 1, wherein the heat sink is delimited in the second direction by a first delimiting side, wherein the at least one first connection opening in the first end region is introduced in the first delimiting side, in particular wherein the predetermined contour, along which the two cooling sides are pressed against one another and/or joined together, adjoins the end face delimiting the heat sink in the longitudinal extension direction.

8. The method according to claim 1, wherein the heat sink has a second end region opposite the first end region with respect to the longitudinal extension direction and with a second opening region on the front side opening into the environment, wherein a second connection unit with at least one second connection opening is formed from the second end region, which is different from the second opening region.

9. An inter-cell cooling unit for a battery, wherein the inter-cell cooling unit was manufactured by the method according to claim 1.

10. A battery for a motor vehicle with an inter-cell cooling unit according to claim 9, comprising:
a cell bar unit which has an inter-cell cooling unit and a cell bar with a plurality of prismatic battery cells arranged next to one another in the longitudinal extension direction of the inter-cell cooling unit, wherein the cell bar is arranged on the inter-cell cooling unit in such a way that one of the two cell sides with the largest area of a respective battery cell faces the inter-cell cooling unit, in particular wherein the battery comprises a plurality of cell bar units arranged next to one another in the third direction.

11. The method according to claim 2, wherein the heat sink has a height in a second direction, and a width in a third direction which is smaller than the height, wherein the heat sink has two cooling sides which delimit the heat sink on both sides with respect to the third direction, wherein the two cooling sides are pressed against one another in the first end region along a predetermined contour.

12. The method according to claim 2, wherein after or while the two cooling sides have been or are being pressed together, a part of the first end region is removed along the predetermined contour, in particular is severed.

13. The method according to claim 3, wherein after or while the two cooling sides have been or are being pressed together, a part of the first end region is removed along the predetermined contour, in particular is severed.

14. The method according to claim 2, wherein the two cooling sides are joined together along the predetermined contour, in particular by welding.

15. The method according to claim 3, wherein the two cooling sides are joined together along the predetermined contour, in particular by welding.

16. The method according to claim 4, wherein the two cooling sides are joined together along the predetermined contour, in particular by welding.

17. The method according to claim 2, wherein in the first end region, the first connection opening is introduced, in particular cut out, into at least one of the two cooling sides, in particular wherein a respective first connection opening is introduced, in particular cut out, into each of the two cooling sides in the first end region, so that the two first connection openings are directly opposite one another in the third direction.

18. The method according to claim 3, wherein in the first end region, the first connection opening is introduced, in particular cut out, into at least one of the two cooling sides, in particular wherein a respective first connection opening is introduced, in particular cut out, into each of the two cooling sides in the first end region, so that the two first connection openings are directly opposite one another in the third direction.

19. The method according to claim 4, wherein in the first end region, the first connection opening is introduced, in particular cut out, into at least one of the two cooling sides, in particular wherein a respective first connection opening is introduced, in particular cut out, into each of the two cooling sides in the first end region, so that the two first connection openings are directly opposite one another in the third direction.

20. The method according to claim 5, wherein in the first end region, the first connection opening is introduced, in particular cut out, into at least one of the two cooling sides, in particular wherein a respective first connection opening is introduced, in particular cut out, into each of the two cooling sides in the first end region, so that the two first connection openings are directly opposite one another in the third direction.
